(19) United States
(12) Patent Application Publication
(10) Pub. No.: US 2012/0072620 A1
(43) Pub. Date: Mar. 22, 2012

(54) TERMINAL AND WIRELESS COMMUNICATION METHOD THEREOF

(75) Inventors: Chan Yong JEONG, Seoul (KR); Shin Hwan HWANG, Seongnam (KR); Chul Gyun PARK, Suwon (KR); Dong Woon CHANG, Gyunggi-do (KR); Joun Sup PARK, Suwon (KR)

(73) Assignee: SAMSUNG ELECTRO-MECHANICS CO., LTD., Suwon (KR)

(21) Appl. No.: 13/038,710

(22) Filed: Mar. 2, 2011

(30) Foreign Application Priority Data
Sep. 17, 2010 (KR) 10-2010-0091935

(51) Int. Cl. G06F 3/14

(52) U.S. Cl. 710/29

(57) ABSTRACT

There are provided a terminal capable of selecting a suitable wireless module among a plurality of wireless modules depending on a situation and providing an optimal image even in a state in which a display unit is separated from a main body by performing wireless communication, and a wireless communication method thereof. To enable this, the terminal includes a main body generating and transmitting image data in response to an external input; a display unit mountable on or demountable from the main body, receiving the image data from the main body and displaying an image corresponding to the image data; and a wireless communication unit provided in each of the main body and the display unit, switching a wireless communication frequency band on the basis of a transmission rate of the image data and transmitting the image data to the display unit.

### CROSS-REFERENCE TO RELATED APPLICATIONS

This application claims the priority of Korean Patent Application No. 10-2010-0091935 filed on Sep. 17, 2010, in the Korean Intellectual Property Office, the disclosure of which is incorporated herein by reference.

### BACKGROUND OF THE INVENTION

1. Field of the Invention

The present invention relates to a terminal capable of using a high-definition image through wireless communication even if a main body and a display unit of the terminal are separated from each other and a wireless communication method thereof.

2. Description of the Related Art

Portable terminals, such as laptop computers and the like, are being developed more rapidly. For example, a technology, in which a display unit is mountable on or demountable from a main body and the display unit and the main body perform mutual wireless communications while being separated from each other, is disclosed.

In a portable terminal, an image should be displayed in the same manner in a state in which the display unit and the main body are connected with each other as well as in a state in which the display unit and the main body are separated from each other; however, in actuality, it is difficult to smoothly display an image in a disconnected state due to limitations in wireless communication.

### SUMMARY OF THE INVENTION

An aspect of the present invention provides a terminal capable of performing wireless communication by selecting a suitable wireless module among a plurality of wireless modules depending on a situation and of providing an optimal image even in a state in which a display unit is separated from a main body, and a wireless communication method thereof.

According to an aspect of the present invention, there is provided a terminal including: a main body generating and transmitting image data in response to an external input; a display unit mountable on or demountable from the main body, receiving the image data from the main body, and displaying an image corresponding to the image data; a wireless communication unit provided in each of the main body and the display unit, switching a wireless communication frequency band on the basis of a transmission rate of the image data, and transmitting the image data to the display unit.

The wireless communication unit may include a first wireless communication portion provided in the main body; and a second wireless communication portion provided in the display unit and performing wireless communication with the first wireless communication portion.

Each of the first and second wireless communication portions may include at least two wireless modules that perform wireless communication in different frequency bands.

The wireless modules may include a 60 GHz RF block using a millimeter wave of a 60 GHz band; and a Wi-Fi RF block using a Wi-Fi frequency band.

The first wireless communication portion may further include a control block selecting one of the wireless modules for transmitting the image data on the basis of the transmission rate of the image data.

The control block of the first wireless communication portion may perform wireless communication through the 60 GHz RF block when the transmission rate of the image data is higher than 1 Gbps.

The main body may further include an image switching module transmitting the image data to the first wireless communication portion when the display unit is separated from the main body.

The main body may further include an accessing detecting unit transmitting information regarding mounting or demounting between the display unit and the main body to the image switching module in real time.

According to another aspect of the present invention, there is provided a wireless communication method of a terminal, the method including: verifying whether a display unit is separated from a main body; switching a wireless communication frequency band on the basis of a transmission rate of image data in the main body and transmitting the image data to the display unit when the display unit is separated from the main body; and displaying an image by receiving the image data in the display unit.

The wireless communication frequency band may be switched by using at least two wireless modules performing wireless communication in different frequency bands.

The transmitting of the image data may include: analyzing the image data; and transmitting the image data to the display unit through a 60 GHz RF block using a millimeter wave of a 60 GHz band when the transmission rate of the image data is higher than 1 Gbps according to a result of analyzing the image data.

The method may further include transmitting the image data to the display unit through a Wi-FI RF block using a Wi-Fi frequency band when the transmission rate of the image data is equal to or lower than 1 Gbps according to the result of analyzing the image data.

In the displaying of the image, the wireless communication frequency band may be switched in the display unit and the image data may be received therein when the wireless communication frequency band is switched in the main body during the transmitting of the image data.

According to yet another aspect of the present invention, there is provided a wireless communication method of a terminal, the method including: generating image data in a main body and transmitting the image data to a display unit through a wired path; separating the display unit from the main body; transmitting the image data from the main body to a wireless communication unit; switching, by the wireless communication unit, a wireless communication frequency band on the basis of a transmission rate of the image data and transmitting the image data to the display unit; and displaying an image by receiving the image data in the display unit.

The wireless communication unit may include a first wireless communication portion provided in the main body; and a second wireless communication portion provided in the display unit and performing wireless communication with the first wireless communication portion.

The first wireless communication portion may include a control block calculating the transmission rate of the image data by analyzing the image data.

The control block may analyze the image data in real time to transmit the image data to the display unit by using a 60 GHz RF block using a millimeter wave of a 60 GHz band when the transmission rate of the image data is higher than 1 Gbps and using a Wi-FI RF block using a Wi-Fi frequency band when the transmission rate of the image data is equal to or lower than 1 Gbps.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of a laptop computer according to an exemplary embodiment of the present invention;

FIG. 2 is a perspective view showing the laptop computer of FIG. 1 divided into a main body and a display unit;

FIG. 3 is a schematic block diagram of the main body of FIG. 1;

FIG. 4 is a schematic block diagram of the display unit of FIG. 1;

FIG. 5 is a schematic block diagram of a first wireless communication portion according to an exemplary embodiment of the present invention;

FIG. 6 is a schematic block diagram of a second wireless communication portion according to an exemplary embodiment of the present invention; and

FIGS. 7 and 8 are flowcharts illustrating a wireless communication method of a terminal according to an exemplary embodiment of the present invention.

### DETAILED DESCRIPTION OF THE PREFERRED EMBODIMENT

Prior to the detailed description of the present invention, terms or words used in the specification and the appended claims should not be construed as having normal and dictionary meanings, and should be construed as having meanings and concepts which conform with the spirit of the present invention according to the principle that the inventor can properly define the concepts of the terms in order to describe his/her own invention in the best way. Accordingly, embodiments disclosed in the specification and configurations shown in the accompanying drawings are merely the most preferred embodiment, but are not limited to the spirit and scope of the present invention. Therefore, it will be appreciated that various equivalents and modifications may be included within the spirit and scope of the present invention.

Hereinafter, exemplary embodiments of the present invention will be described in detail with reference to the accompanying drawings. In this case, like reference numerals refer to like elements in the accompanying drawings. Further, a detailed description of known functions and components which may obscure the spirit of the present invention will be omitted. For the same reason, some components are exaggerated or omitted or schematically shown in the accompanying drawings and the size of each component does not fully reflect the actual size.

Hereinafter, exemplary embodiments of the present invention will be described in detail with reference to the accompanying drawings.

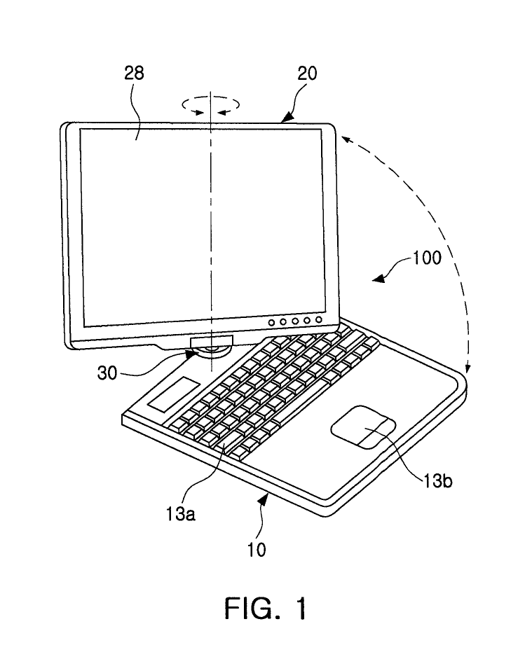

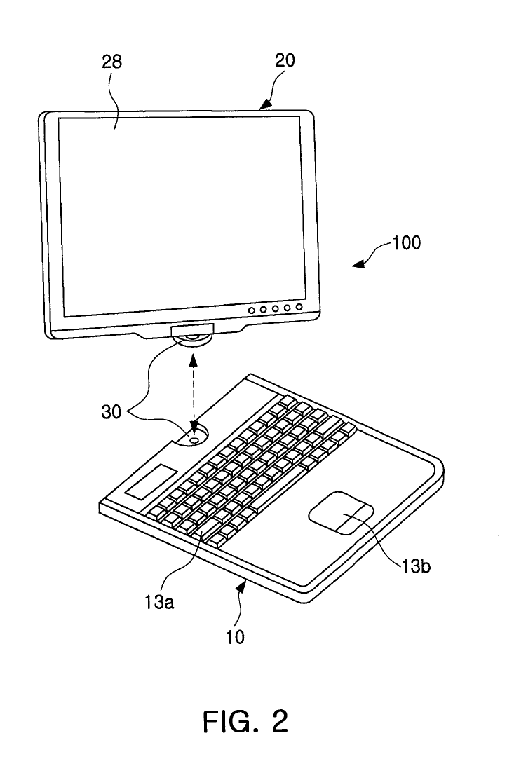

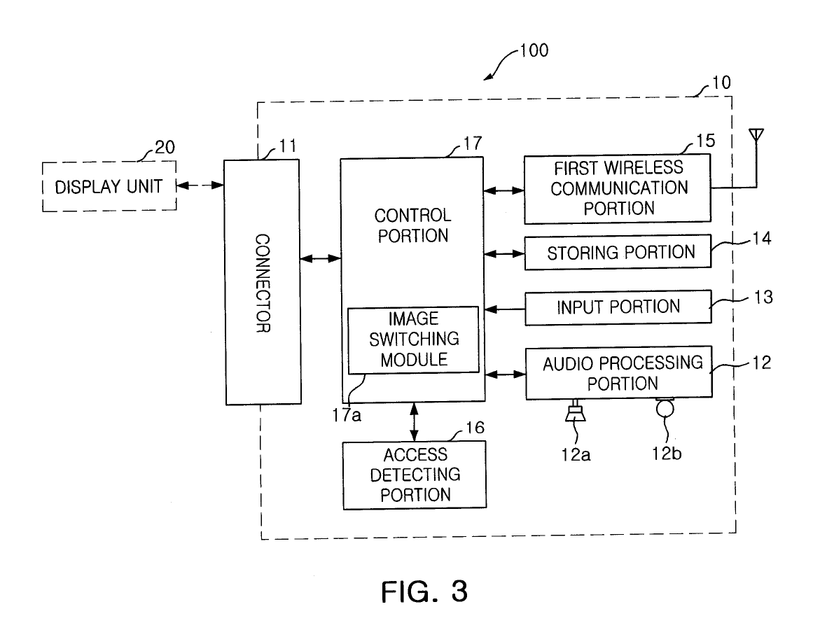

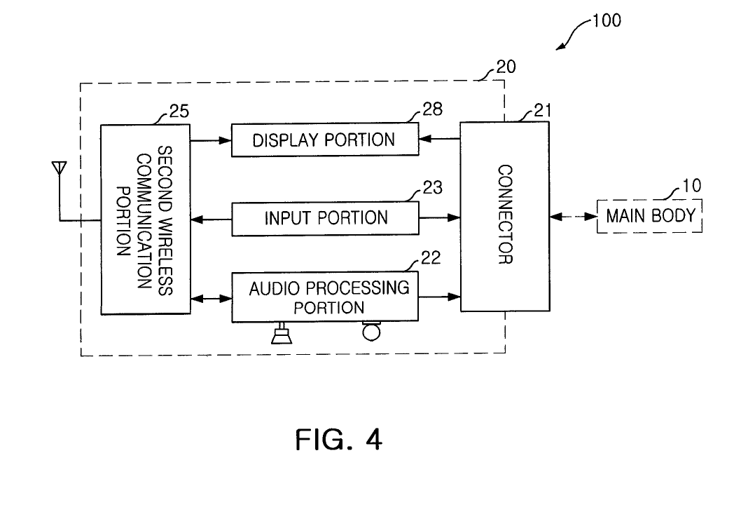

FIG. 1 is a perspective view of a laptop computer according to an exemplary embodiment of the present invention, and FIG. 2 is a perspective view showing the laptop computer of FIG. 1 divided into a main body and a display unit. Further, FIG. 3 is a schematic block diagram of the main body of FIG. 1, and FIG. 4 is a schematic block diagram of the display unit of FIG. 1.

Referring to FIGS. 1 to 4, a terminal according to the exemplary embodiment of the present invention, which is a portable computer which can be driven by a battery, includes a main body 10, a display unit 20, and wireless communication units 15 and 25. The terminal is configured such that the display unit 20 may be respectively mounted and demounted on and from the main body 10.

Herein, the wireless communication units include a first wireless communication portion 15 provided in the main body 10 and a second wireless communication portion 25 provided in the display unit 20 and switches a wireless communication frequency band (i.e., a wireless module) on the basis of a transmission rate of image data transmitted from the main body 10 and transmit the image data to the display unit 20.

The main body 10 includes an audio processing portion 12, an input portion 13, a storing portion 14, a first wireless communication portion 15, an access detecting portion 16, and a control portion 17.

The audio processing portion 12 includes a coder/decoder (CODEC). The CODEC may include a data codec processing packet data and the like, and an audio codec processing an audio signal such as sounds and the like. In particular, the audio processing portion 12 converts digital audio data into an analog audio signal through the audio codec and outputs the corresponding signal to a speaker 12a, and converts an analog audio signal inputted from a microphone 12b into digital audio data through the audio codec and provides the corresponding data to the control portion 17.

The input portion 13 receives a user's operation signal for controlling the main body 10 and transfers the corresponding signal to the control portion 17. For this, the input portion 13 may include a plurality of keys 13a for inputting characters and numbers, a touch pad 13b, and the like.

The storing portion 14 includes a program memory and data memories. The program memory stores programs for controlling a general operation of the main body 10. The data memory stores data generated during executing the programs. For this, the storing portion 14 according the exemplary embodiment may include a RAM, a ROM, an HDD, an ODD, and the like.

The first wireless communication portion 15 is a module for transmitting and receiving data to and from another wireless communication device (e.g., the display unit 20) within a predetermined range through the wireless communication. In the exemplary embodiment, the wireless communication unit provided in the main body 10 is referred to as the first wireless communication portion 15 and the wireless communication unit provided in the display unit 20 is referred to as the second wireless communication portion 25. However, the present invention is not limited thereto.

The first wireless communication portion 15 according to the exemplary embodiment includes both an RF block 15b using a millimeter wave of a 60 GHz band and an RF block 15c using Wi-Fi and selectively uses them as the wireless module.

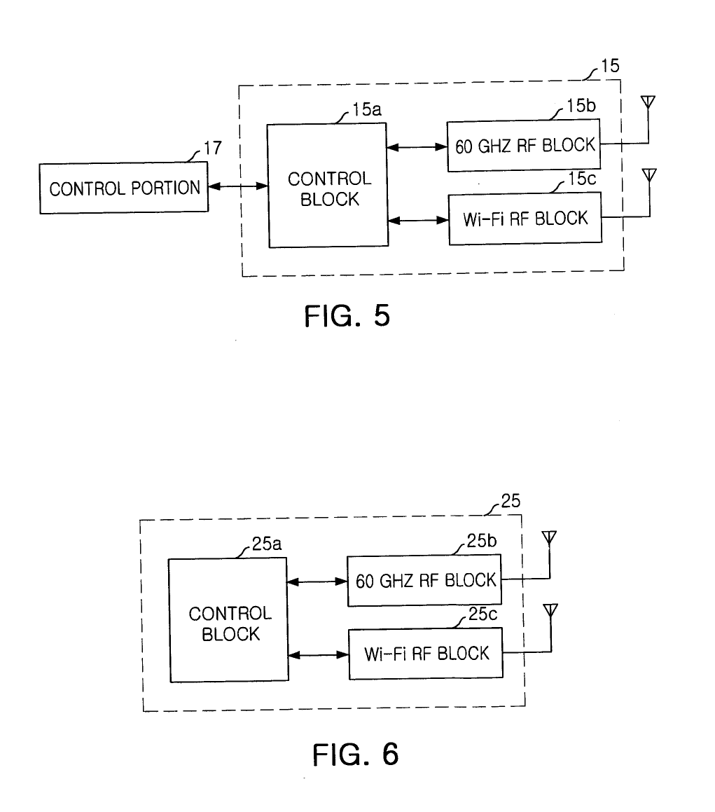

FIG. 5 is a schematic block diagram of a first wireless communication portion according to an exemplary embodiment of the present invention. Referring to FIG. 5, the first wireless communication portion 15 according to the exemplary embodiment includes a Wi-Fi RF block 15c and a 60 GHz RF block 15b, and a control block 15a. Further, each of the 60 GHz RF block 15b and the Wi-Fi RF block 15c includes an antenna corresponding to the frequency thereof.

The Wi-Fi RF block 15c performs wireless communication using Wi-Fi. Wi-Fi, which is widely used at present, primarily uses a 2.4 GHz band. In the case of Wi-Fi wireless communication, diversified codecs (e.g., MPEG1, MPEG2, H.264, and like) are generally used in order to compress data at the time of transmitting image data.

However, since high-definition image data, such as high-definition (HD), full-HD and the like, are very large sizes, there is a limit in transmitting image data through Wi-Fi wireless communication using a relatively low bandwidth.

Therefore, in order to solve the disadvantages of Wi-Fi wireless communication, a wireless module (i.e., a 60 GHz RF block) using a millimeter wave of a 60 GHz band is included.

Since the 60 GHz RF block 15b has no interference with the existing wireless devices and has high data rate (e.g., 4 Gbps or more), the 60 GHz RF block 15b can transmit non-compression image data. Accordingly, a delay problem occurring at the time of compressing and decompressing data using the codec may be solved, and power consumption may be minimized accordingly.

The control block 15a of the first wireless communication portion 15 retrieves a connectable wireless communication device (i.e., a display unit) by being controlled by the control portion 17, and connects with the retrieved wireless communication device to perform an overall operation of wireless communication.

Further, the control block 15a converts image data transmitted from the control portion 17 into data (packet data) for transmission that can be wirelessly transmitted and transmits the corresponding data to the wireless modules 15b and 15c.

Moreover, the control block 15a analyzes the wirelessly transmitted image data at the time of performing the wireless communication and selectively uses the wireless modules 15b and 15c used for the wireless communication on the basis of the analysis result.

In more detail, the control block 15a selects the 60 GHz RF block 15b to perform the wireless communication when the transmission rate of the wirelessly transmitted image data is more than 1 Gbps, and uses the Wi-Fi RF block 15c to perform the wireless communication when the data rate is less than 1 Gbps on the basis of the size of image data displayed through the display unit 20. This will be described in more detail in a wireless communication method to be described below.

Meanwhile, the 60 GHz RF block 15b and the Wi-Fi RF block 15c of the first wireless communication portion 15 according to the exemplary embodiment may be used to transmit the image data to the display unit 20; however, the present invention is not limited thereto. The 60 GHz RF block 15b and the Wi-Fi RF block 15c may be individually connected with diversified wireless communication devices other than the display unit 20 to perform the wireless communication.

Further, the first wireless communication portion 15 according to the exemplary embodiment is not limited to the 60 GHz RF block 15b and the Wi-Fi RF block 15c, and may additionally include diversified wireless communication modules such as a Bluetooth module, an infrared wireless communication module, and the like in order to connect with other wireless communication devices.

The access detecting portion 16 monitors, in real time, whether the display, 20 is coupled to the main body 10 or separated from the main body 10. In addition, when the mounted or demounted state of the display unit 20 is changed, the access detecting portion 16 transmits a signal corresponding to the change to the control portion 17. As a result, the control portion 17 may recognize the mounted or demounted state of the display unit 20 in real time.

The control portion 17 performs an overall control operation of the main body 10. Further, the control portion according to the exemplary embodiment of the present invention judges whether the display unit 20 is mounted on or demounted from the main body 10 through the access detecting portion 16 and selects a transmission path of image data on the basis of the judgment result.

For this, the control portion 17 according to the exemplary embodiment of the present invention includes an image switching module 17a.

The image switching module 17a serves to transmit image data to corresponding components depending on the mounted or demounted state of the main body 10 and the display unit 20. That is, when the main body 10 and the display unit 20 are coupled to be connected to each other, the image switching module 17a transmits the image data directly to a display portion 28 of the display unit 20 through connectors 11 and 21. In contrast, when the main body 10 and the display unit 20 are separated from each other, the image switching module 17a transmits the image data to the second wireless communication portion 25 of the display unit 20 through the first wireless communication portion 15.

Therefore, in the terminal 100 according to the exemplary embodiment, when the display unit 20 is separated from the main body 10, the transmission path of the image data is rapidly switched from a wired path to a wireless path.

Meanwhile, although not shown, the main body 10 of the terminal 100 according to the exemplary embodiment may include a battery inside or outside of the main body 10. The battery supplies power to internal components of the main body 10 and a battery of the display unit 20. The battery may be configured to be charged by an external power source.

The display unit 20 according to the exemplary embodiment is mounted on the main body 10 to be freely rotatable and coupled with the main body 10 to be mounted on or demounted from the body 10.

The display unit 20 includes the display portion 28, an audio processing portion 22, an input portion 23, and the second wireless communication portion 25.

The display portion 28 receives the image data transmitted from the control portion 17 of the main body 10 and displays the corresponding image data on a screen. At this time, the image data is transmitted through different paths (i.e., the wired path or the wireless path) depending on whether the display unit 20 is coupled with the main body 10.

A thin-film display, such as a liquid crystal display (LCD), a light emitting diode (LED) display or the like, may be used as the display portion 28, but the display portion 28 is not limited thereto.

The input portion 23 receives a user's operation signal and transfers the corresponding signal to the control portion 17 of the main body 10. A touch screen added to the outer surface of the display portion 28 may be used as the input portion 23 provided in the display unit 20. In addition, diversified input components such as a camera, a motion sensor, a track ball, a joystick, and the like may be selectively used according to necessity.

Meanwhile, the input signal inputted through the input portion 23 of the display unit 20 may be transmitted to the control portion 17 of the main body 10 through different paths depending on whether or not the display unit 20 and the main body 10 are coupled with each other. That is, when the main body 10 and the display unit 20 are coupled with each other, the input signal is transmitted directly to the control portion 17 of the main body 10 through the wired path using the connectors 21 and 11. In contrast, when the main body 10 and the display unit 20 are separated from each other, the input signal is transmitted to the control portion 17 of the main body 10 through the wireless path using the first and second wireless communication portions 15 and 25.

The audio processing portion 22 provided in the display unit 20 may be configured similarly to the audio processing portion 12 provided in the main body 10. Further, the audio processing portion 22 may be configured to automatically operate when the display unit 20 is separated from the main body 10.

Meanwhile, when the audio processing portion 22 provided in the display unit 20 is configured to process all audio signals, the audio processing portion 12 provided in the main body 10 may be omitted.

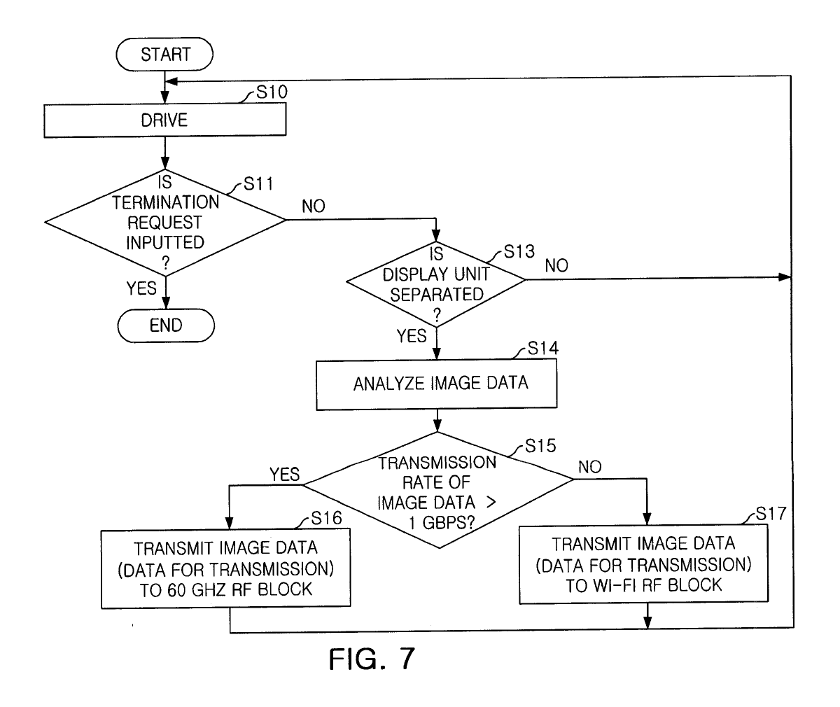

The second wireless communication portion 25 of the display unit 20 is configured similarly to the first wireless communication portion 15 of the main body 10. FIG. 6 is a block diagram schematically illustrating a second wireless communication portion according to an exemplary embodiment of the present invention. Referring to FIG. 6, the second wireless communication portion 25 of the display unit 20 includes a control block 25a, and a 60 GHz RF block 25b and a Wi-Fi RF block 25c which are wireless modules. Further, each of the 60 GHz RF block 25b and the Wi-Fi RF block 25c includes an antenna corresponding to the frequency thereof.

The control block 25a of the second wireless communication portion 25 receives signals inputted from the 60 GHz RF block 25b or the Wi-Fi RF block 25c, converts the input signals into image data, and transmits the converted image data to the display portion 28. Further, the control block 25a converts signals, inputted from the audio processing portion 22, the input portion 23, and the like, into data for transmission that can be wirelessly transmitted, and thereafter, transmits the corresponding data to the currently activated wireless module 25b or 25c.

The display unit 20 according to the exemplary embodiment may include a battery like the main body 10. The battery supplies power to the internal components of the display unit 20 when the display unit 20 is separated from the main body 10. The battery may be charged by the battery of the main body 10 or an external power source when the display unit 20 is coupled to the main body 10.

The main body 10 and the display unit 20 according to the exemplary embodiment are coupled with each other by a hinge unit 30.

As shown in FIGS. 1 and 2, the hinge unit 30 is formed at a location where the main body 10 and the display unit 20 are physically connected with each other. The hinge unit 30 may provide a mechanism to have a structure in which the display portion 28 is opened and closed in a folder type manner like a general laptop computer. Therefore, the display unit 20 is coupled with the main body 10 to freely rotate on the main body 10 by the hinge unit 30.

Further, the hinge unit 30 provides a mechanism to facilitate the coupling and separation of the main body 10 and the display unit 20. To enable this, the hinge unit 30 provides a mechanism to electrically connect the connector 11 of the main body 10 and the connector 21 of the display unit 20 to each other therein.

Therefore, when the main body 10 and the display unit 20 are coupled with each other, the control portion 17 of the main body 10 is directly connected with the display portion 28, the input portion 23, and the audio processing portion 22 of the display unit 20 through the wired path.

Subsequently, a wireless communication method of a terminal according to an exemplary embodiment of the present invention will be described in detail. The configuration of the terminal 100 will be more apparent through the following description of the wireless communication method.

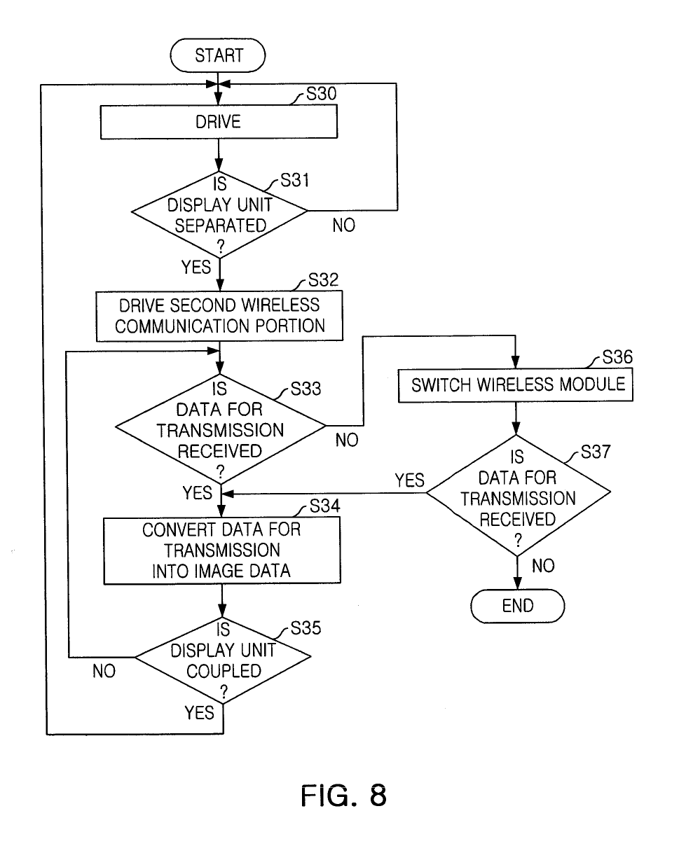

FIGS. 7 and 8 are flowcharts illustrating a wireless communication method of a terminal according to an exemplary embodiment of the present invention. In more detail, FIG. 7 is a flowchart illustrating the wireless communication method of the main body 10, and FIG. 8 is a flowchart illustrating the wireless communication method of the display unit 20.

First, referring to FIG. 7, in the wireless communication method according to the exemplary embodiment, the terminal 100 is firstly driven by a user's operation in operation S10.

In operation S10, the main body 10 and the display unit 20 of the terminal 100 are still coupled with each other. Therefore, the terminal according to the exemplary embodiment operates in the same manner as a known terminal.

Subsequently, the control portion 17 of the terminal 100 verifies whether a user has requested driving termination in operation S11. Herein, driving termination means that the user completes the use of the terminal 100 and terminates a power supply of the terminal 100. Therefore, no request for driving termination means that the user continuously uses the terminal 100.

Meanwhile, operation S11 is preferentially performed in the case in which the user requests termination. Accordingly, operation S11 is preferentially performed when the user's request for driving termination is inputted in all operations to be described below.

As described above, when there is no driving termination request in operation S11, the terminal 100 is continuously driven. In operation S13, the access detecting portion 16 of the main body 10 continuously monitors whether the display unit 20 is separated from the main body 10.

The control portion 17 continuously maintains the driving state of operation S10 when the display unit 20 is coupled with the main body 10 in operation S13. However, when the user separates the display unit 20 from the main body 10, the control portion 17 recognizes that the display unit 20 is separated from the main body 10 through the access detecting portion 16.

As a result, the control portion 17 switches the transmission path for the image data from the wired path to the wireless path. That is, the control portion 17 transmits the image data, transmitted directly to the display portion 28 of the display unit 20, to the first wireless communication portion 15.

Therefore, the control block 15a of the first wireless communication portion 15 receiving the image data analyzes the image data in operation S14.

In general, in the case of a still image or an image having a small amount of movement, the amount of image data to be transmitted is small. Accordingly, in this case, even if a small amount of data is transmitted per hour, this does not have a large influence on the quality of the finally displayed image.

In contrast, in the case of an image having a large variation, such as a movie, the amount of image data to be transmitted is large. Therefore, unless a large amount of data is transmitted per hour, the corresponding image cannot be normally displayed.

Accordingly, the terminal 100 according to the exemplary embodiment transmits data by using the Wi-Fi communication having a relatively low data rate when there is no problem in a displayed image in spite of transmitting a small amount of data per hour. In addition, the terminal 100 transmits data by using the millimeter wave band of 60 GHz having relatively high data rate when an image is naturally maintained only by transmitting a large amount of data per hour.

As a result, the control block 15a of the first wireless communication portion 15 according to the exemplary embodiment calculates the transmission rate of the image data by analyzing the image data received from the control portion 17 in operation S14 and thereafter, and selects one of the 60 GHz RF block 15b and the Wi-Fi RF block 15c that will perform wireless communication with the display unit 20 on the basis of the calculated result in operation S15.

Herein, the control portion 15a according to the exemplary embodiment may select the wireless module on the basis of the transmission rate of 1 Gbps. That is, when the transmission rate of the image data is higher than 1 Gbps, the control block 15a performs wireless communication by selecting the 60 GHz RF block 15b in operation S16 and performs wireless communication by using the Wi-Fi block 15c when the data rate is lower than 1 Gbps in operation S17.

When the wireless communication between the main body 10 and the display unit 20 is performed through such a process, operations S11 to S15 are continuously repeated. In addition, while the operations are repeatedly performed, when the display unit 20 is coupled with the main body 10 in operation S13, operation S14 is not performed any longer.

Further, while the operations are repeatedly performed, when a result of analyzing the image data in operation S14 is different from the analysis result in operation S14 which has been previously performed, the control block 15a selects the wireless modules 15b and 15c in response to the newly analyzed result.

For example, when the transmission rate of the image data in operation S14 is analyzed to be equal to or lower than 1 Gbps, the control block 15a selects the Wi-Fi RF block 15c in operation S15, and operation S17 is performed accordingly. In addition, when the transmission rate of the image data in operation S14 while the operations are repeatedly performed is analyzed to be higher than 1 Gbps, the control block 15a selects the 60 GHz RF block 15b in operation S15, and operation S16 is performed accordingly.

As such, the control block 15a according to the exemplary embodiment changes the wireless modules 15b and 15c in real time according to the transmission rate of the image which is currently transmitted and transmits the image data to the display unit 20. Therefore, the user may use an optimal image without deteriorating the quality of the image or interrupting the image.

Hereinafter, the wireless communication method of the display unit 20 according to the exemplary embodiment will be described.

Referring to FIG. 8, in the wireless communication method of the display unit 20 according to the exemplary embodiment, the terminal 100 is firstly driven by a user's operation in operation S30.

In operation S30, the main body 10 and the display unit 20 of the terminal 100 are still coupled with each other. Therefore, the terminal according to the exemplary embodiment operates in the same manner as a known terminal.

Subsequently, the display unit 20 is separated from the main body 10 in operation S31. At this time, it may be verified whether the display unit 20 and the main body 10 are separated from each other depending on whether the image data transmitted from the connector 21 to the display portion 28 is present or not or whether the power of the display unit 20 is supplied from the main body 10.

When it is verified that the display unit 20 is separated from the main body 10, the control block 25a of the second wireless communication portion 25 drives the wireless modules 25b and 25c in operation S32. At this time, the control block 25a does not recognize which wireless module of the 60 GHz RF block 25b and the Wi-Fi RF block 25c is used for image data transmission. Accordingly, the control block 25a drives both the 60 GHz RF block 25b and the Wi-Fi RF block 25c to receive all transmitted signals and thereafter, analyzes the received signals to verify the wireless module 25b or 25c through which the image data is received.

When the control block 25a verifies the wireless module 25b or 25c, through which the image data is received, in operation S32, the control block 25a receives the image data through the corresponding wireless module 25b or 25c in operation S33.

The received image data is the data for transmission, which is converted by the control block 15a of the main body 10 so as to facilitate wireless communication. Accordingly, the control block 25a receives the data for transmission through the wireless module and simultaneously reconverts the received data into image data in real time in operation S34.

In addition, the converted image data is transmitted to the display portion 28 and an image corresponding to the image data is displayed in the display portion 28.

Meanwhile, while performing operations S32 to S34, the control block 25a continuously verifies whether the display unit 20 is again coupled with the main body 10 in operation S35. In addition, when the display unit 20 is coupled with the main body 10, the process returns to operation S30 and the terminal is driven in the same manner as described above.

However, when the display unit 20 is continuously separated from the main body 10, the control block 25a performs operation S33 to verify whether the data for transmission is received.

Meanwhile, when data reception is suddenly interrupted while the data for transmission is received in operation S33, the activated wireless module 15b or 15c may be switched to the other wireless module 15b or 15c by the control block 15a of the main body 10. Accordingly, when reception of the data for transmission is suddenly interrupted in operation S33, the control block 25a enters operation S36 to stop the driving of the activated wireless module 25b or 25c, which is receiving the data for transmission, and to drive the other wireless module 25b or 25c.

In the case in which the reception of the data for transmission is interrupted by switching the activated wireless module 15b or 15c to the other wireless module 15b or 15c by the control block 15a of the main body 10 as described above, the wireless module 25b or 25c is correspondingly switched in operation S37, and thus the second wireless communication portion 25 may receive the data for transmission again. Therefore, the control block 25a enters to operation S34 to convert the data for transmission into the image data and transmit the corresponding image data to the display portion 28.

Meanwhile, in the case in which the data for transmission is not received in operation S37 despite the switching of the wireless module 25b or 25c in operation S36, it can be understood that the data for transmission may not be transmitted by the main body 10 or a wireless signal may not be received because the display unit 20 is too distant from the main body 10.

Therefore, in this case, the control block 15a allows the display unit 20 to enter a standby state (e.g., a power saving state in which the driving of the display portion is temporarily interrupted) and thereafter, repeatedly switches the wireless module 25b or 25c and finds the signal transmitted from the main body 10. Further, when the standby state is extended, the driving of the display unit 20 may be terminated.

In the terminal and the wireless communication method thereof according to the exemplary embodiments as described above, the display unit is separated from the main body, and each of the main body and the display unit using at least two different frequency bands performs wireless communication therebetween.

In addition, at least two wireless modules that perform wireless communication may be switched depending on the transmission rate of the image data transmitted to the display unit.

Further, the terminal according to the exemplary embodiment performs low-power wireless communication by using a frequency band (e.g., a Wi-Fi wireless communication band) having a small amount of data transmission when the image shows a small variation, and performs wireless communication in a 60 GHz band having a large amount of data transmission when the size of the image data is large.

That is, since the terminal only performs wireless communication in the 60 GHz band when a high-definition image is displayed and uses the Wi-Fi wireless communication which operates with lower power for other general images, power consumed in the display unit can be minimized.

Further, an optimal image is displayed through the display unit separated from the main body, even while consuming minimum power.

Meanwhile, the terminal and the wireless communication method thereof according to the present invention are not limited to the above-mentioned exemplary embodiments and various modifications can be made by those skilled in the art without departing from the spirit of the present invention.

For example, in the above-described exemplary embodiment, the case in which the wireless module for the transmission of the image data is selected by the control block of the main body is described as an example; however, the present invention is not limited thereto and the control portion of the main body or an additional control unit may be used.

Further, in the above-described exemplary embodiment, the case in which the 60 GHz RF block and the Wi-Fi RF block are provided as the wireless modules is described as an example; however, the present invention is not limited thereto and even a wireless module that can perform local wireless communication can be variously applicable.

Further, in the above-described exemplary embodiment, the case in which the wireless module is selected on the basis of the transmission rate of the image data is described as an example. However, in the case in which the size of the image data can be verified, various criteria therefor may be used.

Moreover, in the above-described exemplary embodiment, the laptop computer is described as an example of the portable terminal; however, the present invention is not limited thereto and an electronic device which includes the main body and the display unit and is configured to separate the display unit from the main body can be widely applicable.

As set forth above, in a terminal and a wireless communication method thereof according to exemplary embodiments of the present invention, a main body and a display unit are separated from each other, and each of which uses at least two different frequency bands to perform wireless communication therebetween. In addition, at least two wireless modules that perform wireless communication are switched depending on the rate at which image data is transmitted to the display unit.

Further, the terminal according to the exemplary embodiment performs low-power wireless communication by using a frequency band (e.g., a Wi-Fi wireless communication band) having a small amount of data transmission when the image shows a small variation and performs wireless communication in a 60 GHz band having a large amount of data transmission when the size of the image data is large.

That is, since the terminal performs wireless communication in the 60 GHz band only when a high-definition image is displayed and uses the Wi-Fi wireless communication which operates with lower power for other general images, power consumed in the display unit can be minimized.

Further, an optimal image can be displayed through the display unit separated from the main body even with consuming minimum power.

While the present invention has been shown and described in connection with the exemplary embodiments, it will be apparent to those skilled in the art that modifications and variations can be made without departing from the spirit and scope of the invention as defined by the appended claims.

What is claimed is:

1. A terminal comprising:
a main body generating and transmitting image data in response to an external input;
a display unit mountable on or demountable from the main body, receiving the image data from the main body, and displaying an image corresponding to the image data; and
a wireless communication unit provided in each of the main body and the display unit, switching a wireless communication frequency band on the basis of a transmission rate of the image data and transmitting the image data to the display unit.

2. The terminal of claim 1, wherein the wireless communication unit comprises:
a first wireless communication portion provided in the main body; and
a second wireless communication portion provided in the display unit and performing wireless communication with the first wireless communication portion.

3. The terminal of claim 2, wherein each of the first and second wireless communication portions includes at least two wireless modules that perform wireless communication in different frequency bands.

4. The terminal of claim 3, wherein the wireless modules comprise:
a 60 GHz RF block using a millimeter wave of a 60 GHz band; and
a Wi-Fi RF block using a Wi-Fi frequency band.

5. The terminal of claim 4, wherein the first wireless communication portion further includes a control block selecting one of the wireless modules for transmitting the image data on the basis of the transmission rate of the image data.

6. The terminal of claim 5, wherein the control block of the first wireless communication portion performs wireless communication through the 60 GHz RF block when the transmission rate of the image data is higher than 1 Gbps.

7. The terminal of claim 2, wherein the main body further includes an image switching module transmitting the image data to the first wireless communication portion when the display unit is separated from the main body.

8. The terminal of claim 7, wherein the main body further includes an accessing detecting unit transmitting information regarding mounting or demounting between the display unit and the main body to the image switching module in real time.

9. A wireless communication method of a terminal, the method comprising:
verifying whether a display unit is separated from a main body;
switching a wireless communication frequency band on the basis of a transmission rate of image data in the main body and transmitting the image data to the display unit when the display unit is separated from the main body; and
displaying an image by receiving the image data in the display unit.

10. The method of claim 9, wherein the wireless communication frequency band is switched by using at least two wireless modules performing wireless communication in different frequency bands.

11. The method of claim 9, wherein the transmitting of the image data comprises:
analyzing the image data; and
transmitting the image data to the display unit through a 60 GHz RF block using a millimeter wave of a 60 GHz band when the transmission rate of the image data is higher than 1 Gbps according to a result of analyzing the image data.

12. The method of claim 11, further comprising: transmitting the image data to the display unit through a Wi-FI RF block using a Wi-Fi frequency band when the transmission rate of the image data is equal to or lower than 1 Gbps according to the result of analyzing the image data.

13. The method of claim 9, wherein, in the displaying of the image, the wireless communication frequency band is switched in the display unit and the image data is received thereinwhen the wireless communication frequency band is switched in the main body during the transmitting of the image data.

14. A wireless communication method of a terminal, the method comprising:
generating image data in a main body and transmitting the image data to a display unit through a wired path;
separating the display unit from the main body;
transmitting the image data from the main body to a wireless communication unit;
switching, by the wireless communication unit, a wireless communication frequency band on the basis of a transmission rate of the image data and transmitting the image data to the display unit; and
displaying an image by receiving the image data in the display unit.

15. The method of claim 14, wherein the wireless communication unit includes a first wireless communication portion provided in the main body, and a second wireless communication portion provided in the display unit and performing wireless communication with the first wireless communication portion.

16. The method of claim 15, wherein the first wireless communication portion includes a control block calculating the transmission rate of the image data by analyzing the image data.

17. The method of claim 16, wherein the control block analyzes the image data in real time to transmit the image data to the display unit by using a 60 GHz RF block using a millimeter wave of a 60 GHz band when the transmission rate of the image data is higher than 1 Gbps and using a Wi-FI RF block using a Wi-Fi frequency band when the transmission rate of the image data is equal to or lower than 1 Gbps.
